(19) United States
(12) Patent Application Publication
(10) Pub. No.: US 2025/0303988 A1
(43) Pub. Date: Oct. 2, 2025

(54) GENERATION DEVICE FOR SETTING VALUE SET

(71) Applicant: TOYOTA JIDOSHA KABUSHIKI KAISHA, Toyota-shi (JP)

(72) Inventors: Takahiro Ishii, Toyota-shi (JP); Akifumi Tsukamoto, Toyoake-shi (JP); Ryo Sugiyama, Nisshin-shi (JP)

(73) Assignee: TOYOTA JIDOSHA KABUSHIKI KAISHA, Toyota-shi (JP)

(21) Appl. No.: 19/022,120

(22) Filed: Jan. 15, 2025

(30) Foreign Application Priority Data
Mar. 29, 2024 (JP) 2024-056980

(51) Int. Cl. B60R 16/037

(52) U.S. Cl. CPC B60R 16/037

(57) ABSTRACT

The generation device generates a mode setting value set including a setting value for each operation device. The execution device acquires a plurality of combination data from the vehicle. The execution device stores the combination data in the storage device. The execution device selects the vehicle environment information satisfying the selection condition from the vehicle environment information included in the combination of the plurality of combination data. The execution device specifies the setting information satisfying the specific condition among the setting information of the combination including the selected vehicle environment information. The execution device generates a plurality of setting values included in the specified setting information as a mode setting value set in the vehicle environment indicated by the selected vehicle environment information.

### CROSS-REFERENCE TO RELATED APPLICATION

This application claims priority to Japanese Patent Application No. 2024-056980 filed on Mar. 29, 2024, incorporated herein by reference in its entirety.

### BACKGROUND

### 1. Technical Field

The present disclosure relates to a generation device for a setting value set.

### 2. Description of Related Art

Japanese Unexamined Patent Application Publication No. 2023-93003 (JP 2023-93003 A) describes a control device for controlling a seat device that is an operation device in a relaxation mode.

### SUMMARY

In order to set the indoor environment of the vehicle to a predetermined environment, the control device described in JP 2023-93003 A may collectively control a plurality of operation devices as control targets. When the control device collectively controls the operation devices, the control device needs a setting value set including setting values for the operation devices. Further, the setting value set is desirably set for each vehicle environment. However, the setting of the setting values of the operation devices for each of various vehicle environments may excessively increase a burden on the developer.

The present disclosure relates to a generation device configured to generate a setting value set for collectively controlling a plurality of operation devices mounted on a vehicle. The setting value set includes setting values for the operation devices.

The generation device includes:
a storage unit; and
an execution unit.
the execution unit is configured to:
acquire, from the vehicle, a plurality of pieces of combination data each indicating a combination of vehicle environment information indicating a vehicle environment of the vehicle and setting information indicating the setting values for the operation devices individually operated in the vehicle environment indicated by the vehicle environment information;
store the acquired pieces of combination data in the storage unit;
select, in the pieces of combination data stored in the storage unit, the vehicle environment information satisfying a predetermined selection condition among pieces of the vehicle environment information included in a plurality of the combinations;
identify the setting information satisfying a predetermined specific condition among pieces of the setting information in the combinations including the selected vehicle environment information; and generate a plurality of the setting values included in the identified setting information as the setting value set in the vehicle environment indicated by the selected vehicle environment information.

With the above configuration, the generation device can generate the setting value set in the vehicle environment based on the combination data satisfying the selection condition and the specific condition among the combinations of the vehicle environment information and the setting information acquired from the vehicle. As a result, the generation device can suppress an excessive increase in the burden on the developer due to the setting of the setting values of the operation devices for each of various vehicle environments.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram showing a vehicle;

FIG. 2 is a schematic diagram illustrating a generation system for generating a setting value set;

FIG. 3 is a schematic diagram showing a setting value set; and

FIG. 4 is a flowchart illustrating a series of processes for generating a setting value set.

### DETAILED DESCRIPTION OF EMBODIMENTS

### Embodiment

Hereinafter, an embodiment of a generation device for a setting value set will be described with reference to the drawings. First, a vehicle equipped with a control device that controls a plurality of operation devices using a setting value set will be described.

### Outline of Vehicle

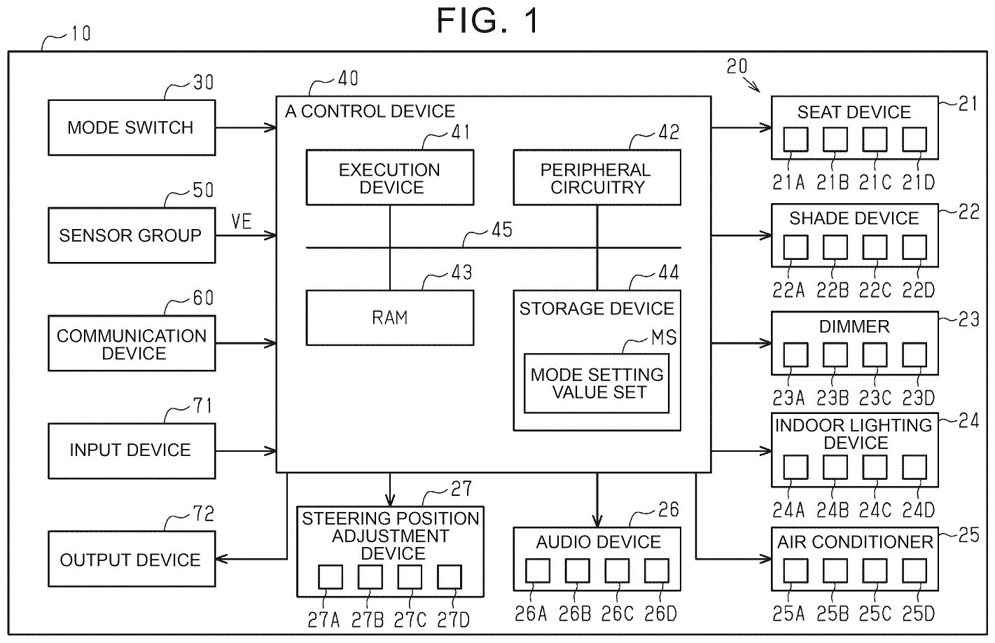

As illustrated in FIG. 1, the vehicle 10 includes a plurality of operation devices 20. That is, the plurality of operation devices 20 are mounted on the vehicle 10. The operation device 20 is a device that affects the indoor environment of the vehicle 10 by operating.

The plurality of operation devices 20 includes a seat device 21, a shade device 22, a dimmer 23, an indoor lighting device 24, an air conditioner 25, an audio device 26, and a steering position adjustment device 27.

The seat device 21 affects the attitude of the occupant in the vehicle 10 while the occupant is in the vehicle. The seat device 21 has a seat main body 21A. Further, the seat device 21 includes a seat operation mechanism 21B for operating the seat main body 21A, a seat actuator 21C for operating the seat operation mechanism 21B, and a control unit 21D for controlling the seat actuator 21C.

The seat main body 21A includes a seat cushion and a seat back. The seat cushion is slidably connected to the vehicle 10 through a slide mechanism such as a seat operation mechanism 21B provided on the floor of the vehicle 10. The slide mechanism includes a lower rail fixed to the floor of the vehicle 10 and an upper rail attached to the lower rail so as to be slidable in the front-rear direction. Driving the sliding motor of the seat actuator 21C causes the upper rail to slide relative to the lower rail. In this way, the seat device 21 has a sliding function of the seat main body 21A.

The seat back is connected to a rear end portion of the seat cushion of the seat main body 21A so as to be rotatable with respect to the seat cushion through a reclining mechanism of the seat operation mechanism 21B. By driving the reclining motor of the seat actuator 21C, the seat back rotates with respect to the seat cushion with an axis extending in the widthwise direction of the vehicle 10 as a rotation axis. In this way, the seat device 21 has a reclining function of the seat main body 21A.

When a seat operating switch (not shown) is operated, the control unit 21D drives the reclining motor of the seat actuator 21C. Thus, the control unit 21D controls the slide position, which is the vehicle-front-rear position of the seat main body 21A. Further, the control unit 21D drives the reclining motor of the seat actuator 21C by operating a seat operating switch (not shown). Thus, the control unit 21D controls the reclining position, which is the angle of the seat back with respect to the seat cushion.

The shade device 22 affects the brightness of the indoor environment of the vehicle 10, the opening feeling of the occupant in the vehicle 10, and the like by changing the range covering the window glass in the vehicle 10. One shade device 22 is provided for each window glass. In the present embodiment, the shade device 22 is provided in each of the roof glass provided on the roof of the vehicle 10 and the rear glass provided on the rear of the vehicle 10. In FIG. 1, only one shade device 22 is illustrated.

The shade device 22 has a shade main body 22A. Further, the shade device 22 includes a shade operation mechanism 22B for operating the shade main body 22A, a shade actuator 22C for operating the shade operation mechanism 22B, and a control unit 22D for controlling the shade actuator 22C.

The shade main body 22A is a curtain body that covers the glass of the vehicle 10 from the inside of the room of the vehicle 10. The shade main body 22A is operatively connected via a shade operation mechanism 22B so as to be in a closed state covering the glass and an open state not covering the glass. When the shade main body 22A is wound up by the driving of the motor that is the shade actuator 22C, the shade main body 22A is opened. Further, the shade main body 22A is rewound by the driving of the shade actuator 22C, so that the shade main body 22A is closed. In this way, the shade device 22 has the shade function of the shade main body 22A.

When a roof shade operating switch (not shown) is operated, the control unit 22D drives the shade actuator 22C of the shade device 22 provided in the roof glass. Thus, the control unit 22D controls the opening and closing of the shade device 22 provided in the roof glass. Further, the control unit 22D drives the shade actuator 22C of the shade device 22 provided in the rear glass by operating a rear shade operating switch (not shown). Thus, the control unit 22D controls the opening and closing of the shade device 22 provided in the rear glass.

The dimmer 23 changes the light transmittance of the window glass in the vehicle 10, thereby affecting the amount of light inserted into the interior of the vehicle 10 from the outside. The dimmer 23 includes a dimming glass 23A, a dimming mechanism 23B that changes the light transmittance of the dimming glass 23A, a dimming actuator 23C that operates the dimming mechanism 23B, and a control unit 23D that controls the dimming actuator 23C.

The dimmer 23 is provided on a roof glass of the vehicle 10. The dimming glass 23A is a roof glass of the vehicle 10. The dimming glass 23A includes two glass layers and a light control film layer sandwiched between the two glass layers. The dimming film layer changes the dispersal and orientation of the micro-materials contained in the dimming film layer according to the applied voltage by the dimming mechanism 23B. The dimming actuator 23C is driven to drive the dimming film. As a result, the operation of the dispersion and the orientation of the minute material contained in the light control film layer is changed. As a consequence, the dimming glass 23A becomes a dimming mode in which the light transmittance from the outside of the vehicle 10 is low due to the applied voltage, or a transmission mode in which the light transmittance from the outside of the vehicle 10 is high due to the transparency. In this way, the dimmer 23 has a light control function of the dimming glass 23A.

The control unit 23D drives the dimming actuator 23C by operating a dimming control switch (not shown). Thus, the control unit 23D controls the condition of the dimming glass 23A.

The indoor lighting device 24 changes the mode of lighting for illuminating the interior of the vehicle 10, thereby affecting the brightness and the like of the interior of the vehicle 10. The indoor lighting device 24 includes a lamp 24A including a light emitting mechanism 24B, a lighting actuator 24C for operating the light emitting mechanism 24B, and a control unit 24D for controlling the lighting actuator 24C.

The indoor lighting device 24 is provided in the interior of the vehicle 10. The lamp 24A is, for example, a LED. When the light emitting mechanism 24B is operated by driving a switch that is a lighting actuator 24C, the lamp 24A is in a lighting state or a non-lighting state. In addition, the lamp 24A can realize fade-in lighting and fade-out lighting by driving the lighting actuator 24C. In this way, the indoor lighting device 24 has a lighting function.

The control unit 24D controls the driving of the lighting actuator 24C by operating an illumination switch (not shown). Thus, the control unit 24D controls the status of the lamp 24A. In the present embodiment, the vehicle 10 includes a plurality of indoor lighting devices 24.

The air conditioner 25 adjusts the temperature in the vehicle 10, thereby affecting the temperature environment such as the temperature in the room of the vehicle 10. The air conditioner 25 includes an air conditioner main body 25A including an air conditioning mechanism 25B, an air conditioning actuator 25C for operating the air conditioning mechanism 25B, and a control unit 25D for controlling the air conditioning actuator 25C.

The air outlet of the air conditioner main body 25A is provided so as to blow air toward the indoor space of the vehicle 10. By operating the air conditioning mechanism 25B by driving the air compressor and the heat exchanger, which are air conditioning actuator 25C, the air conditioner main body 25A sends the temperature-adjusted air from the air outlet. In this way, the air conditioner 25 has an air-conditioning function.

The control unit 25D controls driving of the air-conditioning actuator 25C by operating an air-conditioning switch (not shown). Thus, the control unit 25D controls the air blowing condition from the air blowing port of the air conditioner main body 25A.

The audio device 26 affects the sound environment in the interior of the vehicle 10 by changing the output of the sound in the vehicle 10. The audio device 26 includes a speaker 26A including an audio mechanism 26B, an audio actuator 26C that operates the audio mechanism 26B, and a control unit 26D that controls the audio actuator 26C.

The speaker 26A outputs sound by operating the audio mechanism 26B inside the vehicle 10. When the audio actuator 26C is vibrated, the speaker 26A outputs sound due to the vibration. In this way, the audio device 26 has an acoustic function.

When an acoustic switch (not shown) is operated, the control unit 26D drives the audio actuator 26C. Thus, the control unit 26D controls the sound outputted from the speaker 26A.

The steering position adjustment device 27 adjusts the position of the steering wheel 27A in the vehicle 10, thereby affecting the space of the driver's seat in the vehicle 10. The steering position adjustment device 27 includes a steering wheel 27A and a position adjusting mechanism 27B capable of adjusting the position of the steering wheel 27A. The steering position adjustment device 27 includes a position adjustment actuator 27C that operates the position adjusting mechanism 27B and a control unit 27D that controls the position adjustment actuator 27C.

The steering wheel 27A is provided in the driver's seat of the vehicle 10. The position of the steering wheel 27A can be adjusted in the front-rear direction and the up-down direction of the vehicle 10 by the position adjusting mechanism 27B. The position adjusting mechanism 27B realizes a so-called tilt and telescopic function. The position of the steering wheel 27A in the vehicle 10 is changed by the driving of the motor which is the position adjustment actuator 27C. In this way, the steering position adjustment device 27 has a position adjustment function.

When a steering position adjustment switch (not shown) is operated, the control unit 27D drives the position adjustment actuator 27C. Thus, the control unit 27D controls the position of the steering wheel 27A.

As described above, the plurality of operation devices 20 can be individually operated by operating switches provided for each operation device 20. The vehicle 10 includes a mode switch 30 and a control device 40. The mode switch 30 is operated by a user to output a signal indicating that mode control is performed in a mode for collectively controlling the plurality of operation devices 20 to the control device 40. In addition, the mode switch 30 outputs a signal indicating a mode in which mode control is performed to the control device 40 in response to an operation by the user.

The control device 40 collectively controls the plurality of operation devices 20 by mode control. The control device 40 acquires a signal indicating that mode control is performed from the mode switch 30. Further, the control device 40 acquires a signal indicating a mode in which mode control is performed from the mode switch 30. Each mode is a mode for realizing an indoor environment of the vehicle 10.

The control device 40 includes an execution device 41 that is a CPU, peripheral circuitry 42, a RAM 43, a storage device 44, and a bus 45. The bus 45 connects the execution device 41, the peripheral circuitry 42, RAM 43, and the storage device 44 so as to be able to communicate with each other. The execution device 41 performs information processing by executing various programs stored in the storage device 44. The peripheral circuitry 42 includes a circuitry that generates a clock signal that defines an internal operation, a power supply circuitry, a reset circuitry, and the like. RAM 43 stores information generated by the execution device 41. The storage device 44 stores a mode setting value set MS to be used in accordance with the mode control.

The mode setting value set MS is a data set that defines the setting value SV of the operation device 20 corresponding to the mode for realizing the indoor environment of the vehicles 10. The mode setting value set MS includes, for each mode, information indicating the operation device 20 to be operated and information indicating the operation content of the operation device 20 to be operated.

Upon acquiring a signal indicating that the mode control is performed from the mode switch 30, the execution device 41 starts executing the mode control. When the execution of the mode control is started, the execution device 41 determines the mode based on the mode acquired from the mode switch 30 and the mode setting value set MS. Next, the execution device 41 refers to the mode setting value set MS to determine the operation device 20 to be operated in the determined mode. Next, the execution device 41 refers to the mode setting value set MS to determine the operation content of the operation device 20 to be operated as determined. Then, the execution device 41 causes the determined operation target operation device 20 to operate with the determined operation content. After the operation of the operation content is performed, the execution device 41 ends the series of processes.

The vehicle 10 includes a sensor group 50 including a plurality of sensors and a communication device 60. The sensor group 50 includes a plurality of sensors for acquiring vehicle environment information VE indicating the vehicle environment of the vehicle 10. The sensor group 50 detects, for example, the outside air temperature range TO of the vehicle 10, the weather W of the area where the vehicle 10 is located, and the time zone TM including the time in the area where the vehicle 10 is located. Further, the sensor group 50 detects, for example, the type of the road on which the vehicle 10 is traveling, the brightness around the position where the vehicle 10 is located, and the number of passengers of the vehicle 10. The sensor group 50 outputs the detected vehicle-environment-information VE to the control device 40. The communication device 60 is capable of wireless communication via a wireless communication network.

The vehicle 10 includes an input device 71 and an output device 72. The input device 71 is operated to input information to the control device 40. The output device 72 outputs information from the control device 40. Specifically, the input device 71 and the output device 72 are implemented as a touch display. In the present embodiment, the output device 72 outputs an image indicating information to the display.

### Generation System

Next, a method for generating the mode setting value set MS will be described.

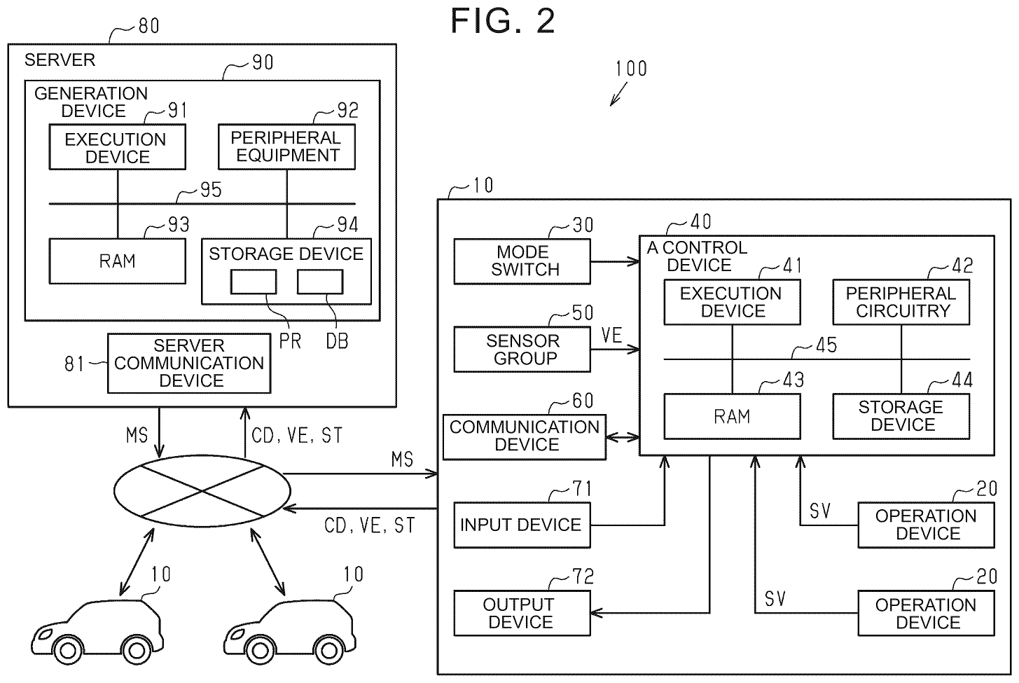

As illustrated in FIG. 2, the generation system 100 includes a plurality of vehicles 10 and a server 80. Note that one vehicle 10 among the plurality of vehicles 10 is shown in detail, and the other vehicles 10 are not shown in detail. Further, a plurality of operation devices 20 of the vehicle 10 are partially omitted.

The control device 40 acquires the vehicle-environment-information VE from the sensor group 50. In addition, the control device 40 acquires setting SV indicating the operation content of the operation device 20 when it is individually operated by operating a switch provided for each operation device 20. The setting value SV is, for example, a value indicating a reclining position in the seat device 21. The setting value SV is, for example, a value indicating an open state or a closed state in the shade device 22. The setting value SV is, for example, a value indicating a dimming mode or a transmission mode in the dimmer 23.

The communication device 60 of the vehicle 10 can wirelessly communicate with the server 80 via a wireless communication network. The control device 40 of the vehicle 10 generates combination data CD indicating a combination of the vehicle environment information VE acquired from the sensor group 50 and the setting information ST including the setting value SV of the plurality of operation devices 20 when the vehicle environment is indicated by the vehicle environment information VE. The control device 40 transmits the combination data CD from the communication device 60 to the servers 80.

The server 80 includes a server communication device 81 and a generation device 90. The server communication device 81 is capable of wirelessly communicating with the vehicle 10 via a wireless communication network. The generation device 90 is a device that generates the mode setting value set MS based on the data received by the server-communication device 81.

The generation device 90 includes an execution device 91 that is a CPU, peripheral circuitry 92, a RAM 93, a storage device 94, and a bus 95. In the present embodiment, the execution unit is the execution device 91, and the storage unit is the storage device 94. The bus 95 communicatively connects the execution device 91, the peripheral circuitry 92, RAM 93, and the storage device 94 to each other. The execution device 91 performs information processing by executing various programs stored in the storage device 94. The peripheral circuitry 92 includes a circuitry that generates a clock signal that defines an internal operation, a power supply circuitry, a reset circuitry, and the like. RAM 93 stores data generated in association with execution by the execution device 91. The storage device 94 stores a generation program PR for generating the mode setting value set MS and a database DB used in executing the generation program PR.

Each time the combination data CD is acquired from the vehicles 10, the execution device 91 causes the storage device 94 to store the acquired combination data CD in the database DB. As a result, the generation device 90 acquires a plurality of combination data CD, so that the database DB includes a plurality of combination data CD.

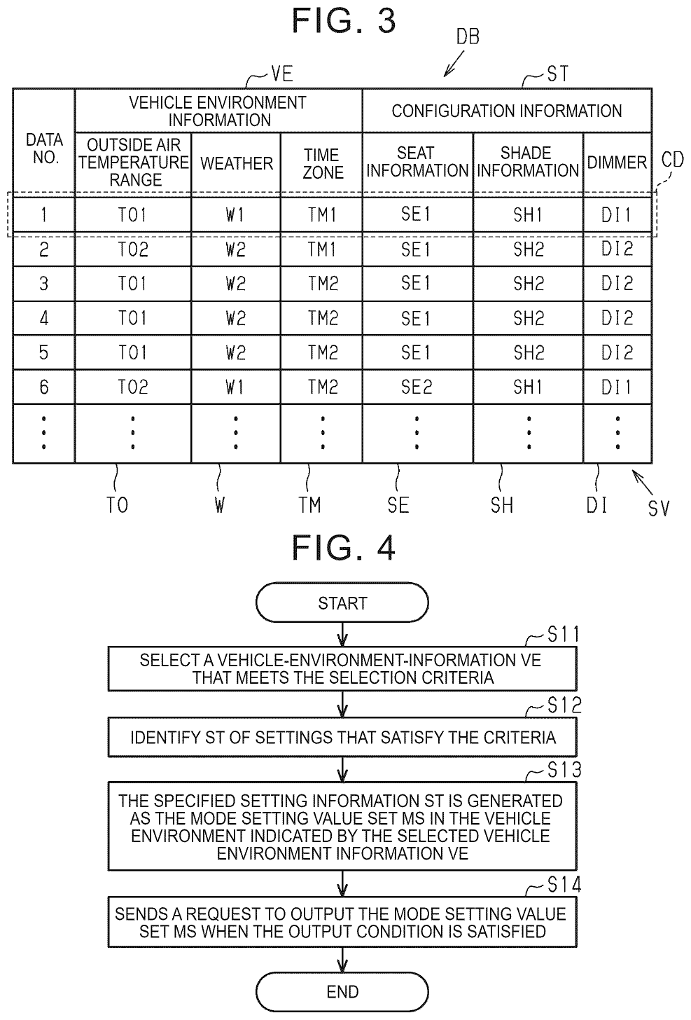

As shown in FIG. 3, the database DB includes a plurality of combination data CD. The combination data CD are assigned data numbers in the order in which they are stored. The combination data CD includes a vehicle environment information VE and a setting information ST including a plurality of setting value SV associated with the vehicle environment information VE. In FIG. 3, one combination data CD is denoted by a reference numeral.

The vehicle-environment-information VE includes, for example, an outside air temperature range TO, a weather W, and a time zone TM. The outside air temperature range TO is a temperature range including the outside air temperature among a plurality of predetermined temperature ranges. For example, the plurality of temperature ranges indicates whether or not the temperature range exceeds 30 degrees Celsius. In the present embodiment, the first outside air temperature range TO1 is a temperature range exceeding 30 degrees. The second outside air temperature range TO2 is a temperature range of 30 degrees or less.

The weather W indicates whether or not the weather is in a rainy state. In the present embodiment, the first weather W1 is in a rainy condition. The second weather W2 is not in a rainy condition. The time zone TM is a time period including the time at which the other vehicle-environment-information VE is acquired among the plurality of predetermined times. In the present embodiment, the first time zone TM1 is a time period from sunrise to sunset in one day. The second time zone TM2 is a time period from sunset to sunrise in one day.

The setting value SV includes, for example, a seat information SE of the seat device 21, a shade information SH of the shade device 22, and a dimming information DI of the dimmer 23. The seat-information SE indicates whether or not the reclining position is a predetermined position. In the present embodiment, the first seat-information SE1 indicates a first predetermined position. The second seat-information SE2 indicates a second defined position that differs from the first defined position.

The shade information SH indicates whether the shade device 22 is in an open state or a closed state. In the present embodiment, the first shade information SH1 indicates that the shade device 22 is open. The second shade information SH2 indicates that the shade device 22 is closed.

The dimming information DI indicates whether the dimmer 23 is in the dimming mode or the transmission mode. In the present embodiment, the first dimming information DI1 indicates that the dimmer 23 is in the dimming mode. The second dimming information DI2 indicates that the dimmer 23 is in the transmission mode.

### Generating Setting Value Set

The execution device 91 starts execution of the generation-program PR at a predetermined cycle. The specified period is, for example, 24 hours.

As illustrated in FIG. 4, when the execution device 91 starts execution of the generation program PR, S11 process is started first. In S11, the execution device 91 refers to the database DB stored in the storage device 94, and selects the vehicle-environment-information VE that satisfies the predetermined selection criteria in the combination indicated by the plurality of combination data CD. The selection condition is that the number of the same combination is equal to or greater than a predetermined number. The combination having the same vehicle environment information VE indicates that the information included in the vehicle environment information VE of the two combinations matches. In the present embodiment, the two combinations are combinations having the same vehicle environment information VE when the outside air temperature range TO, the weather W, and the time zone TM included in the vehicle environment information VE of the two combinations all match. The specified number is, for example, 100 pieces. In the present embodiment, the execution device 91 selects the vehicle-environment-information VE including, for example, the first outside air temperature range TO1, the second weather W2, and the second time zone TM2. Thereafter, the execution device 91 advances the process to S12.

In S12, the execution device 91 specifies the setting information ST satisfying the predetermined specification condition from the combination-setting information ST including the selected vehicle-environment information VE. The specified condition is that a ratio of the number of combinations that are the same setting information ST to the number of combinations including the selected vehicle-environment information VE is equal to or greater than a predetermined ratio. For example, the specified ratio is set at 80%. In the present embodiment, the execution device 91 specifies the setting information ST including, for example, the first seat information SE1, the second shade information SH2, and the second dimming information DI2. Thereafter, the execution device 91 advances the process to S13.

In S13, the execution device 91 generates a plurality of setting values SV included in the specified setting information ST as mode setting value set MS in the vehicle environment indicated by the selected vehicle environment information VE. In the present embodiment, the execution device 91 generates the identified first seat information SE1, the second shade information SH2, and the second dimming information DI2 as the mode setting value set MS in the vehicle environment of the selected first outside air temperature range TO1, the second weather W2, and the second time zone TM2. Thereafter, the execution device 91 advances the process to S14.

In S14, the execution device 91 outputs, from the server-communication device 81 to the vehicle 10, a request to be presented to the user by outputting the mode setting value set MS generated by S13 to the output device 72. Further, the execution device 91 requests to output the request to the output device 72 when the vehicle 10 satisfies a predetermined output condition. The output condition is determined to be, for example, a vehicle environment indicated by the vehicle environment information VE selected by the vehicle environment of the vehicle 10 after the power of the vehicle 10 is turned from the off state to the on state. Thereafter, the execution device 91 ends the series of processes.

### Operations of Embodiment

According to the above-described embodiment, it is assumed that the plurality of operation devices 20 are individually operated at the same setting-information ST in the same vehicle environment in the plurality of vehicles 10. In this case, the generation device 90 generates the setting information ST operated in the plurality of vehicles 10 as the mode setting value set MS in the vehicle environment. After that, the server 80 transmits, to the plurality of vehicles 10, information indicating the mode setting value set MS in the vehicle environment. In addition, the server 80 transmits the information and, when the output condition is satisfied, transmits, to the plurality of vehicles 10, a request for outputting the mode setting value set MS in the vehicle environment indicated by the information from the output device 72. When the output condition is satisfied, the vehicle 10 outputs, to the output device 72, images indicating the mode setting value set MS in the vehicle environment.

### Effects of Embodiment

(1) The generation device 90 acquires the combination data CD from the vehicles 10. The combination data CD indicates a combination of the vehicle environment information VE and the setting information ST including the setting value SV for each operation device 20 individually operated when the vehicle environment is indicated by the vehicle environment information VE. Then, the generation device 90 can generate the mode setting value set MS in the selected vehicular environment by the combination satisfying the selection condition and the specifying condition among the combinations indicated by the plurality of acquired combination data CD. Therefore, even if there are a plurality of operation devices 20, the developer does not need to consider the combination of the vehicular environment and the setting information ST, the combination of the plurality of setting value SV, and the content of the setting value SV for each operation device 20. In this way, it is possible to suppress excessive effort from being applied to the developer by generating the mode setting value set MS.
(2) According to the above-described embodiment, the number of combinations having the same vehicle-environment-information VE is equal to or larger than a predetermined number. The specific condition is that a ratio of the number of combinations that are the same setting-information ST to the number of selected combinations is equal to or greater than a specified ratio. According to this configuration, it is possible to generate the setting-information ST set in a large number in the past as the mode setting value set MS in the vehicle environment.
(3) According to the above-described embodiment, the plurality of operation devices 20 includes a seat device 21, a shade device 22, and a dimmer 23. Therefore, for example, while using the reclining function in the seat device 21, in order to adjust the amount of light entering the room from the outside of the vehicle 10 using the shade device 22 and the dimmer 23, it can be operated individually. Under such circumstances, when a new mode setting value set MS is generated, it is possible to collectively control the light amount as a mode for adjusting the light amount while using the reclining function, and thus it is not necessary to individually operate the mode.
(4) According to the above-described embodiment, the output condition is that the vehicle environment indicated by the vehicle environment information VE of the mode setting value set MS generated by the vehicle environment of the vehicle 10 after the power of the vehicle 10 is turned from the off state to the on state. Therefore, when the vehicle environment of the vehicle 10 changes, the user of the vehicle 10 can grasp the mode setting value set MS suitable for the changed vehicle environment when the vehicle environment changes.

### OTHER EMBODIMENTS

The present embodiment can be realized with the following modifications. The present embodiment and the following modifications can be combined with each other within a technically consistent range to be realized.

The output condition may be when the power of the vehicle 10 is turned from the off state to the on state. In this case, the user of the vehicle 10 can recognize the mode setting value set MS when the power of the vehicle 10 is turned from the off state to the on state. The server 80 may omit the output condition and transmit only the request to output to the output device 72 to the vehicle 10.

The selection condition and the specific condition are not limited to the example of the above-described embodiment. For example, the selection condition may be a condition for selecting a vehicle environment information VE in which some parameters match among the parameters included in the vehicle environment information VE.

The plurality of operation devices 20 preferably include at least two or more of the seat device 21, the shade device 22, the dimmer 23, the indoor lighting device 24, the air conditioner 25, and the audio device 26. In this case, by giving various sensations to the user of the vehicle 10, it is easy to realize the indoor environment of the vehicle 10 differently. The plurality of operation devices 20 may include a steering position adjustment device 27.

The mode setting value set MS generated by the generation device 90 may be a setting value set to be collectively controlled. That is, the control in which the setting value set is used is not limited to the control for realizing the specific mode by the mode control for making the specific mode. In the above embodiment, the plurality of setting values SV included in the setting information ST have been described as the seat information SE, the shade information SH, and the dimming information DI, but the present disclosure is not limited thereto. For example, the setting information ST may include, as the setting value SV, a value indicating a set state of the indoor lighting device 24, a value indicating a set state of the air conditioner 25, and a value indicating a set state of the audio device 26.

The generation device 90 may be configured as a circuitry including one or more processors that execute various processes in accordance with a computer program (software). Note that the generation device 90 may be configured as a circuitry including one or more dedicated hardware circuitry such as an application-specific integrated circuitry (ASIC) that executes at least some of the various processes, or a combination thereof. The processor includes a CPU and a memory such as a random access memory (RAM) and a ROM. The memory stores a program code or an instruction configured to execute the CPU to perform processes. The memory, that is, the computer-readable medium includes any available media that can be accessed by a general purpose or special purpose computer. The same applies to the control device 40.

What is claimed is:

1. A generation device configured to generate a setting value set for collectively controlling a plurality of operation devices mounted on a vehicle, the setting value set including setting values for the operation devices, the generation device comprising:
a storage unit; and
an execution unit, wherein the execution unit is configured to:
acquire, from the vehicle, a plurality of pieces of combination data each indicating a combination of vehicle environment information indicating a vehicle environment of the vehicle and setting information indicating the setting values for the operation devices individually operated in the vehicle environment indicated by the vehicle environment information;
store the acquired pieces of combination data in the storage unit;
select, in the pieces of combination data stored in the storage unit, the vehicle environment information satisfying a predetermined selection condition among pieces of the vehicle environment information included in a plurality of the combinations;
identify the setting information satisfying a predetermined specific condition among pieces of the setting information in the combinations including the selected vehicle environment information; and
generate a plurality of the setting values included in the identified setting information as the setting value set in the vehicle environment indicated by the selected vehicle environment information.

2. The generation device according to claim 1, wherein:
the selection condition is that the number of the combinations including the same vehicle environment information stored in the storage unit is equal to or larger than a predetermined number; and
the specific condition is that a ratio of the number of combinations including the same setting information to the number of the selected combinations is equal to or larger than a predetermined ratio.

3. The generation device according to claim 1, wherein the operation devices include at least two of a seat device, a shade device, a dimmer, an indoor lighting device, an air conditioner, and an audio device.

4. The generation device according to claim 1, wherein the execution unit is further configured to output, after the setting value set is generated, a request to present the generated setting value set under a condition that power of the vehicle is turned from OFF to ON.

5. The generation device according to claim 1, wherein the execution unit is further configured to output, after the setting value set is generated, a request to present the generated setting value set under a condition that the vehicle environment of the vehicle becomes the vehicle environment indicated by the vehicle environment information of the generated setting value set after power of the vehicle is turned from OFF to ON.
